(19) United States
(12) Patent Application Publication
(10) Pub. No.: US 2011/0044238 A1
(43) Pub. Date: Feb. 24, 2011

(54) METHODS AND SYSTEMS FOR UPDATING CHANNEL DESCRIPTOR INFORMATION IN WIMAX NETWORKS

(75) Inventors: Guangming Shi, San Diego, CA (US); Tom Chin, San Diego, CA (US); Feng K. Guo, San Diego, CA (US); Fangqi Hu, San Diego, CA (US); Patrick Lim, San Diego, CA (US); Kuo-Chun Lee, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/543,073

(22) Filed: Aug. 18, 2009

(51) Int. Cl. H04W 4/00

(52) U.S. Cl. 370/328

(57) ABSTRACT

This application provides techniques for updating channel descriptor (CD) information in a wireless communications system.

### TECHNICAL FIELD

Certain embodiments of the present disclosure generally relate to wireless communications and, more particularly, to transitioning between different versions of downlink channel descriptor (DCD) and/or uplink channel descriptor (UCD) messages. SUMMARY

Certain embodiments of the present disclosure provide a method for wireless communications. The method generally includes obtaining a new version of a channel descriptor (CD), transmitting messages containing the new version of the CD and a current version of the CD, prior to the new version of the CD taking effect, and transmitting only messages containing the new version of the CD after the new version of the CD takes effect, at least until another new version of the CD is obtained.

Certain embodiments of the present disclosure provide a method for wireless communications. The method generally includes receiving, from a base station, an indication that a new version of a channel descriptor (CD) is to be transmitted in a subsequent frame, and obtaining the CD in the subsequent frame prior to the new version of the CD going into effect.

Certain embodiments of the present disclosure provide an apparatus for wireless communications. The apparatus generally includes logic for obtaining a new version of a channel descriptor (CD), logic for transmitting messages containing the new version of the CD and a current version of the CD, prior to the new version of the CD taking effect, and logic for transmitting only messages containing the new version of the CD after the new version of the CD takes effect, at least until another new version of the CD is obtained.

Certain embodiments of the present disclosure provide an apparatus for wireless communications. The apparatus generally includes logic for receiving, from a base station, an indication that a new version of a channel descriptor (CD) is to be transmitted in a subsequent frame, and logic for obtaining the CD in the subsequent frame prior to the new version of the CD going into effect.

Certain embodiments of the present disclosure provide an apparatus for wireless communications. The apparatus generally includes means for obtaining a new version of a channel descriptor (CD), means for transmitting messages containing the new version of the CD and a current version of the CD, prior to the new version of the CD taking effect, and means for transmitting only messages containing the new version of the CD after the new version of the CD takes effect, at least until another new version of the CD is obtained.

Certain embodiments of the present disclosure provide an apparatus for wireless communications. The apparatus generally includes means for receiving, from a base station, an indication that a new version of a channel descriptor (CD) is to be transmitted in a subsequent frame, and means for obtaining the CD in the subsequent frame prior to the new version of the CD going into effect.

Certain embodiments of the present disclosure provide a computer-program product for wireless communications, comprising a computer readable medium having instructions stored thereon, the instructions being executable by one or more processors. The instructions generally include instructions for obtaining a new version of a channel descriptor (CD), instructions for transmitting messages containing the new version of the CD and a current version of the CD, prior to the new version of the CD taking effect, and instructions for transmitting only messages containing the new version of the CD after the new version of the CD takes effect, at least until another new version of the CD is obtained.

Certain embodiments of the present disclosure provide a computer-program product for wireless communications, comprising a computer readable medium having instructions stored thereon, the instructions being executable by one or more processors. The instructions generally include instructions for receiving, from a base station, an indication that a new version of a channel descriptor (CD) is to be transmitted in a subsequent frame, and instructions for obtaining the CD in the subsequent frame prior to the new version of the CD going into effect.

In certain embodiments of this application, such as described in one or more of the summary paragraphs above, the channel descriptor (CD) can include, for example, one or more of a downlink channel descriptor (DCD) and/or one or more of an uplink channel descriptor (UCD).

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and receiver in accordance with certain embodiments of the present disclosure.

FIG. 4 illustrates conventional periodic broadcasting of new version of downlink channel descriptor (DCD) and/or uplink channel descriptor (UCD) by a base station (BS).

FIG. 5 is a flow diagram of example operations for broadcasting messages with DCD/UCD, in accordance with certain embodiments of the present disclosure.

FIG. 5A is a block diagram of means corresponding to the example operations of FIG. 5 for broadcasting messages with DCD/UCD, in accordance with certain embodiments of the present disclosure.

FIG. 6 illustrates example broadcasts corresponding to the operations illustrated in FIG. 5.

FIG. 7 illustrates a flow diagram of example operations for indicating to Mobile Stations (MSs), the version of an upcoming DCD/UCD broadcast, in accordance with certain embodiments of the present disclosure.

FIG. 7A is a block diagram of means corresponding to the example operations of FIG. 7 for indicating to MSs, the version of an upcoming DCD/UCD broadcast, in accordance with certain embodiments of the present disclosure.

FIG. 8 illustrates an example format of a Broadcast Control Pointer Information Element (IE), in accordance with certain embodiments of the present disclosure.

FIG. 9 illustrates example broadcasts based on the operations illustrated in FIG. 7.

FIG. 10 illustrates a flow diagram of operations for determining how to handle an upcoming DCD/UCD broadcast, in accordance with certain embodiments of the present disclosure.

FIG. 10A is a block diagram of means corresponding to the example operations of FIG. 10 for determining how to handle an upcoming DCD/UCD broadcast, in accordance with certain embodiments of the present disclosure.

### DETAILED DESCRIPTION

In wireless communications systems, such as WiMAX systems, channel descriptor (CD) messages provide information relating to the physical characteristics of the downlink channel and/or uplink channel. As used in this application, a CD message refers to either at least one downlink channel descriptor (DCD), or at least one uplink channel descriptor (UCD), or sometimes one or more of both (DCD/UCD). These physical characteristics may include various types of modulation and coding schemes, Forward Error Correction (FEC) codes etc. associated with a downlink/uplink channel. Mobile stations (MSs) may use information about these physical characteristics for communication via a downlink/uplink channel.

In order to communicate these physical characteristics to mobile MSs, a base station (BS) may periodically broadcast DCD/UCD messages. MSs may receive and parse these messages in order to determine the physical characteristics. Because the physical characteristics may change over time, new versions of downlink/uplink channel descriptor (DCD/UCD) messages are broadcast by the BS. In order to indicate to the MSs, the version of a broadcast DCD/UCD, the BS may use a configuration change count (CCC) field indicating a version of the DCD/UCD message.

When a new version of DCD/UCD goes into effect, the BS typically broadcasts the new version of the DCD/UCD message so the MS will have the information and can smoothly transition once the new version goes into effect. Unfortunately, this approach may have limitations. For example, when a new version of DCD/UCD is broadcast, some MSs may still be waiting for current version of DCD/UCD in order to perform pending communications. For example, these MSs may have missed earlier broadcasts of the DCD/UCD messages if they were in a sleep mode or scanning neighbor BSs. In any case, these MSs may have to suspend communications until they receive the current version of DCD/UCD, which may result in performance degradation and, possibly, an undesirable user experience.

Certain embodiments of the present disclosure provide methods for enhancing handling of downlink channel descriptor DCD/uplink channel descriptor (UCD) version changes in WiMax systems. According to certain embodiments, a base station (BS) may transmit to one or more mobile stations (MSs), messages with current and new versions of DCD/UCD, concurrently. Transmission of both current and new versions of DCD/UCD may ensure that MSs receive whichever version they desire. Accordingly, MSs that did not receive the current version of DCD/UCD, due to being in sleep mode or performing other actions, may receive the current version. MSs that already possess the current version of DCD/UCD may receive the new version. These MSs may desire to receive the new version of DCD/UCD in order to be able to perform downlink/uplink communication when the new version of DCD/UCD goes into effect.

According to certain embodiments, a BS may transmit a Broadcast Control Pointer Information Element (IE) containing frame number of the frame with the next message with DCD/UCD and a new version flag indicating whether the version of DCD/UCD contained in the message is new. Based on the new version flag, if a MS determines that the version of DCD/UCD in the message is a version it desires to receive, it may receive the message in the frame indicated in the Broadcast Control Pointer IE. If the MS determines that the version of DCD/UCD in the message is not a version it is looking for, it may ignore the message. Ignoring the message based on the new version flag may have advantages. For instance, instead of being available to receive the message, the MS may choose to conserve power by going to sleep mode or perform other useful operations such as scanning neighbor BSs etc.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

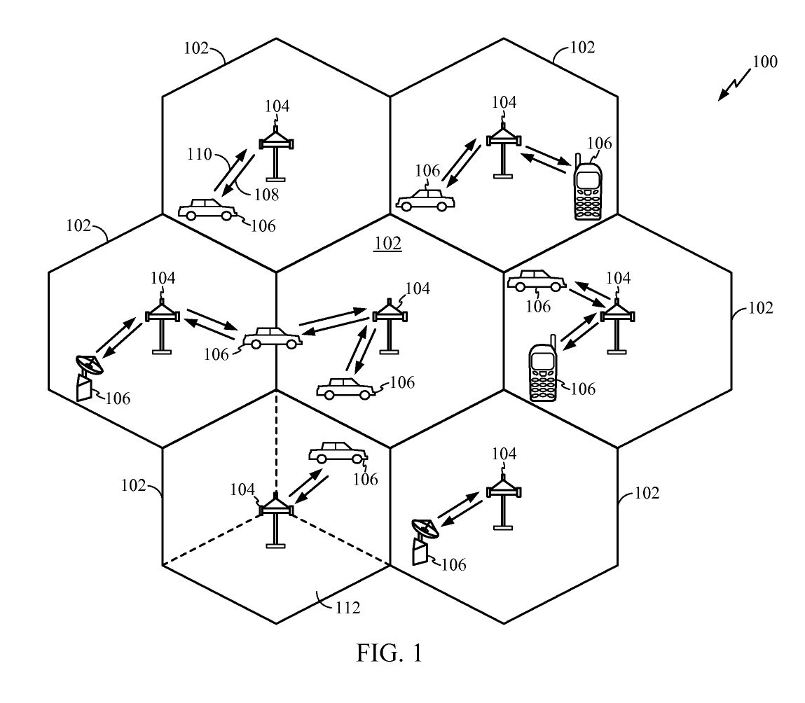

FIG. 1 illustrates an example of a wireless communication system 100 in which embodiments of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

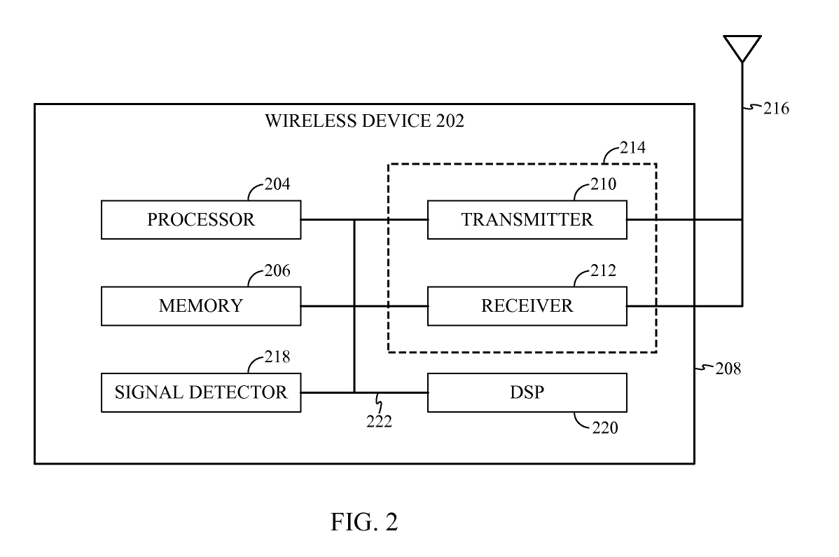

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy per pseudonoise (PN) chips, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

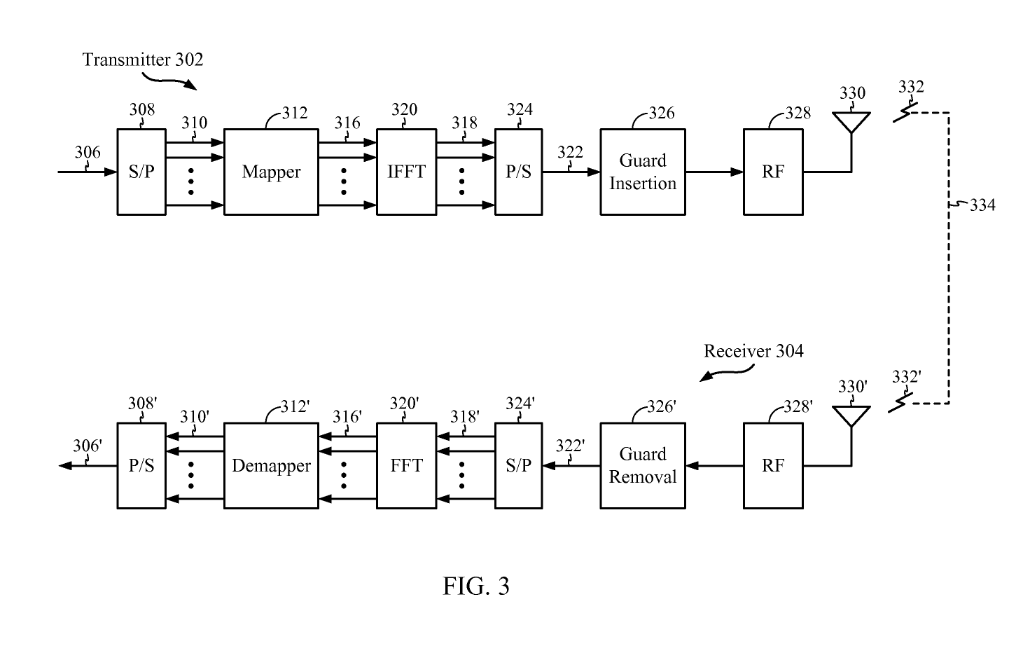

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary Broadcasting of New Version(s) of DCD/UCD

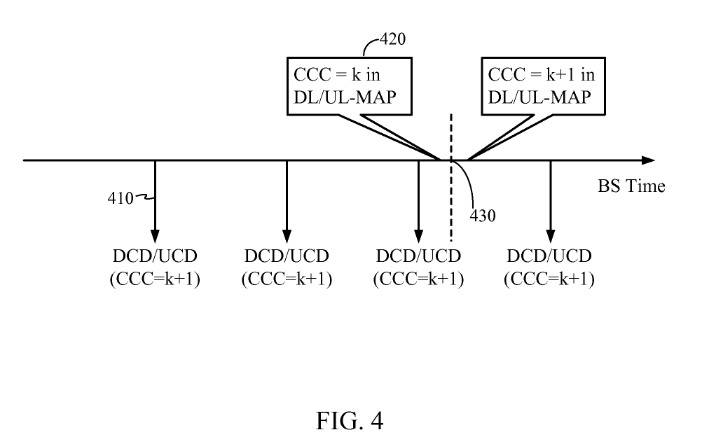

FIG. 4 illustrates conventional periodic broadcasting 400 of a new version of downlink channel descriptor DCD/uplink channel descriptor (UCD) by a base station (BS) in a WiMAX system. As illustrated, the BS may periodically broadcast DCD/UCD messages 410. MSs may receive and parse the message in order to access the information contained in the message. The BS may notify MSs about changes in the physical characteristics by broadcasting a new version of DCD/UCD. In order to indicate the new version to the MSs, the BS may use a configuration change count (CCC) field of the message 410 containing the DCD/UCD. The value of the CCC field may be equal to the version of DCD/UCD contained in the message. The current version of DCD/UCD may be indicated to the MSs via a periodically broadcast Downlink Map (DL-MAP)/Uplink Map (UL-MAP) message such as the message 420 in FIG. 4. The DL/UL-MAP message may contain a DCD/UCD Count field with value equal to the configuration change count (CCC) of the currently used version of DCD/UCD.

When a new version of DCD/UCD goes into effect (e.g., at time 430, as shown in the figure), it may be desired that MSs use this new version for downlink/uplink communication. To facilitate this, the BS may typically broadcast messages 410 containing the new version (e.g., “k+1”) of DCD/UCD before the new version actually goes into effect at time 430, thereby avoiding or at least minimizing disruption of service that may arise if the MSs do not possess the new version of DCD/UCD. When the new version of DCD/UCD goes into effect, CCC value in the DCD/UCD count field of the DL/UL-MAP message 420 may be incremented by one to indicate that the new version of DCD/UCD is now the current version. Accordingly, as may be seen from the figure, value of CCC in the DL/UL-MAP message 420 is “k” before time 430, and “k+1” after time 430. When the BS broadcasts this DL/UL-MAP message with updated CCC indicating the change in version, the MSs may switch to the new version of DCD/UCD for downlink/uplink communication. After time 430, the BS may continue broadcasting messages 410, with the current (i.e., previously new) version of DCD/UCD.

As described above, in certain circumstances, one or more MSs may need the current version of the DCD/UCD for communications, prior to the new version going into effect, for example, if the MSs are in a sleep mode or scanning mode. However, certain embodiments of the present disclosure may help ensure that such MSs are able to obtain the current version of the DCD/UCD.

Exemplary Techniques for Broadcasting Messages with DCD/UCD

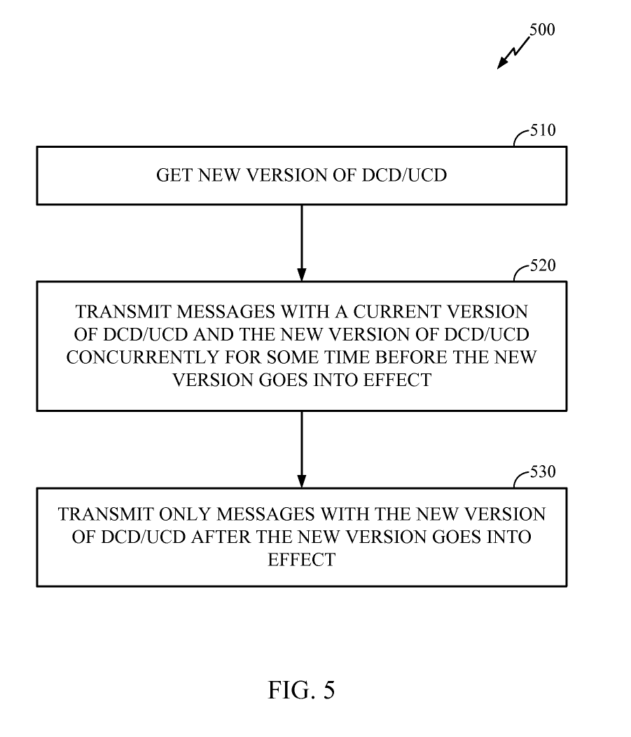

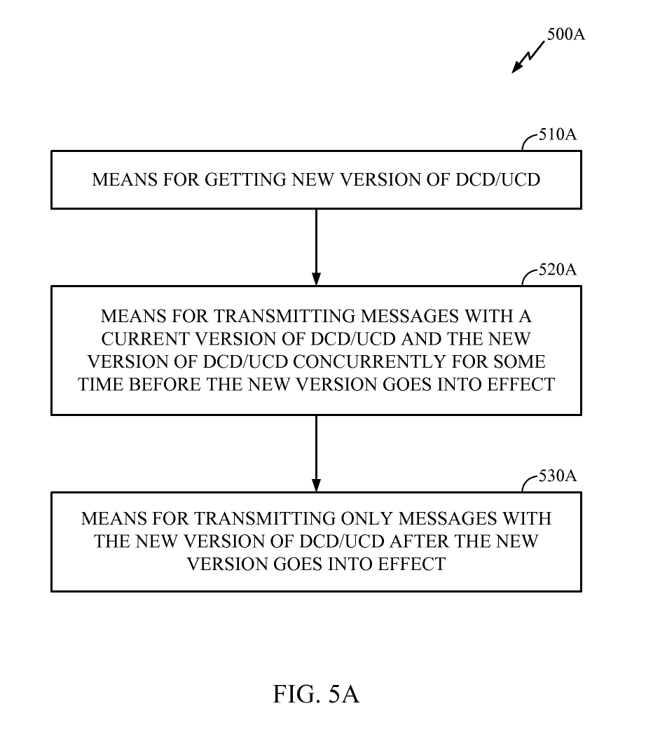

FIG. 5 illustrates a flow diagram of example operations 500 for broadcasting DCD/UCD in accordance with certain embodiments of the disclosure. The operations may be performed, for example, by a BS that utilizes DL/UL-MAP messages with a DCD/UCD Count field to indicate the current version of a DCD/UCD.

The operations 500 may begin, at 510, with the BS getting a new version of DCD/UCD. As described earlier, changes in the physical characteristics of a downlink or uplink channel may lead to a new version of DCD/UCD. The new version DCD/UCD, communicated to MSs, may enable the MSs to be ready for uplink/downlink communication when the new version goes into effect.

At 520, the BS transmits messages with current version of DCD/UCD and the new version of DCD/UCD concurrently. As a result, MSs that have already received the current version may receive the new version and will be ready to promptly communicate when the new version goes into effect. In addition, MSs that had not previously received the current version of DCD/UCD will be able to receive it and communicate prior to the new version going into effect.

At 530, the BS may only transmit the new version of DCD/UCD after the new version goes into effect. Once the new version of DCD/UCD goes into effect, it may become the current version. The previously current version of DCD/UCD is now obsolete, and may not be broadcast any longer. CCC value in the DCD/UCD Count field of the DL/UL-MAP message may be incremented to indicate that the new version is now the current version.

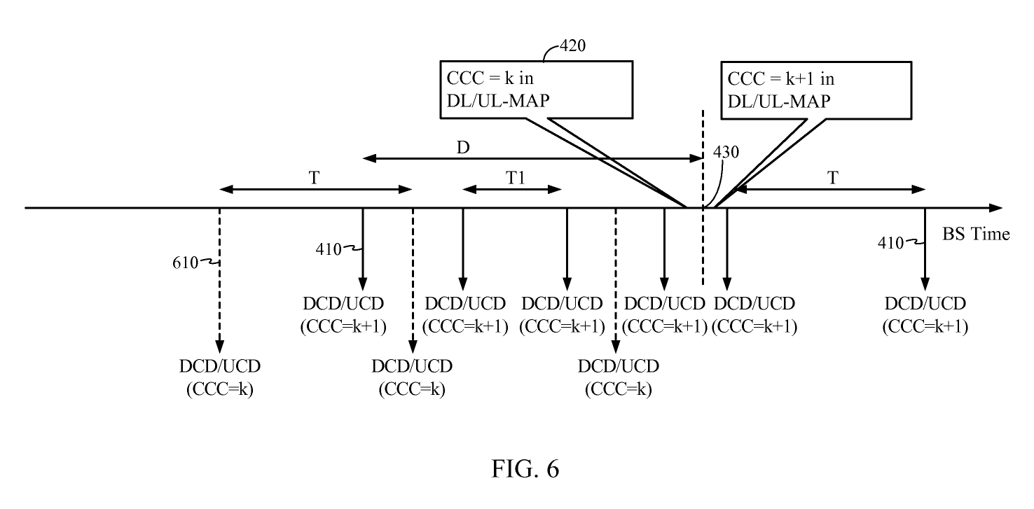

FIG. 6 illustrates example broadcasts 600 by a BS corresponding to the operations 500 illustrated in FIG. 5. As shown in the figure, prior to a new version of the DCD/UCD message going into effect (as indicated by CCC =k+1), the BS may transmit both messages 410 containing the new version of the DCD/UCD and messages 610 containing the current version of DCD/UCD.

As described earlier, MSs that desire to receive the current version of DCD/UCD may benefit from this transmission. MSs may identify the version of DCD/UCD contained in a message from the CCC field of the message. Accordingly, “k” may indicate current version of DCD/UCD and “k+1” may indicate new version of DCD/UCD, as shown in FIG. 5. As illustrated, according to certain embodiments, the BS may transmit messages 410 more frequently (e.g., with a period T1) than messages 610 (transmitted with a different longer period T). T and T1 may be determined by the network for the BS.

As illustrated, transmission of messages 410 may begin at time D before time 430 when the new version of DCD/UCD goes into effect. The value of D may be chosen such that ratio D/T1 may be a suitable value (e.g., D/T1>2). This may ensure that the MSs may receive multiple broadcasts of the new version of DCD/UCD, thus facilitating detection and correction of errors in one or more received broadcasts before the new version goes into effect. The BS may transmit messages 610 with a normal period (e.g., T) decided by the wireless communication system for the BS. If the BS desires to reduce the length of the transition period (i.e., D) and also ensure multiple broadcasts of the new version of DCD/UCD before the new version goes into effect, the BS may choose T1 such that T1 is smaller than T.

After the new version of DCD/UCD goes into effect, the BS may only transmit messages 410 containing the new version of DCD/UCD (until yet a subsequent version is obtained). The transmission may begin from the first frame after the new version goes into effect. DL/UL-MAP message 420 with a DCD/UCD Count field may be used to indicate the version of DCD/UCD currently used. Accordingly, the version under use may be “k” before time 430, and “k+1” after time 430, as shown in the figure.

After time 430, MSs that successfully received messages 410 with the new version of DCD/UCD may be able to perform downlink/uplink communication based on the new version. MSs that did not successfully receive either the current version or the new version before the new version went into effect may look forward to receiving messages 410 with the new version.

### Exemplary Techniques for Indicating the Version of Upcoming DCD/UCD Broadcast

In conventional WiMAX systems, a BS may use a Broadcast Control Pointer Information Element (IE) in a DL-MAP message to indicate to MSs, the frame that contains an upcoming message with DCD/UCD. MSs may use this information to determine when to be available to receive the message. A limitation of the existing Broadcast Control Pointer IE, however, is that it may not indicate whether the upcoming DCD/UCD is a new version. As a result, an MS may wastefully wait and decode messages for a current version of DCD/UCD that they already possess, in some cases refraining from entering a sleep mode which may result in wasted power consumption.

However, certain embodiments of the present disclosure may allow a BS to provide an indication to the MSs, beforehand, whether or not they have already received the version of DCD/UCD contained in an upcoming message. The indication may be provided, for example, as a “new version flag” in a broadcast pointer IE. As a result, an MS may be able to avoid wastefully waiting for and decoding DCD/UCD messages they already possess.

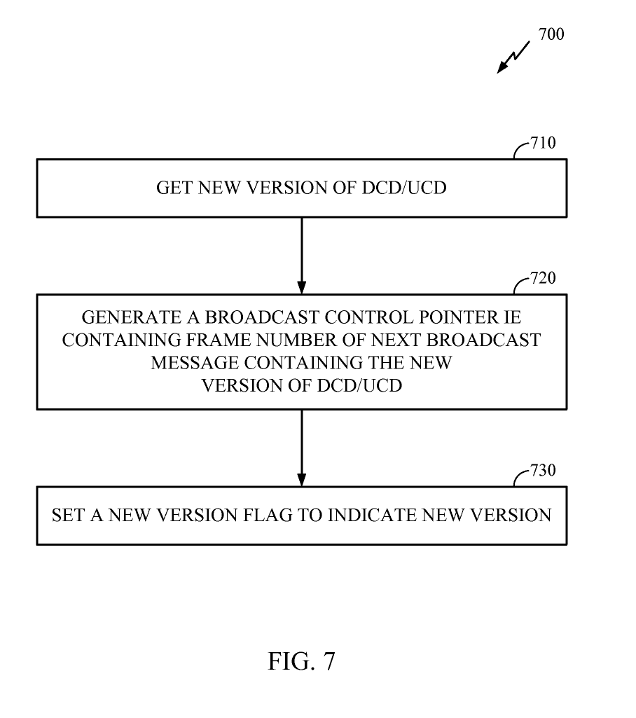

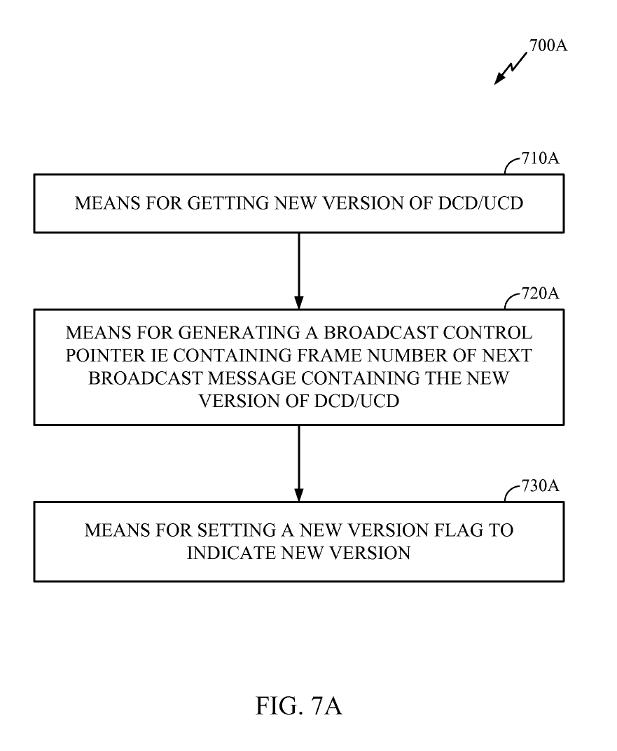

FIG. 7 illustrates a flow diagram of example operations 700 for indicating to MSs, whether an upcoming DCD/UCD broadcast contains a new version or a current version. The operations 700 may be performed, for example, by a BS.

The operations may begin at 710 with the BS obtaining a new version of DCD/UCD. At 720, the BS may generate a Broadcast Control Pointer IE. The Broadcast Control Pointer IE may include a field that contains frame number of the frame with the next broadcast message containing the new version of DCD/UCD.

At 730, the BS may set a new version flag in the Broadcast Control Pointer IE to indicate that the next broadcast DCD/UCD is a new version. An MS, upon receiving the Broadcast Control Pointer IE, may be able to determine how to handle an upcoming message with DCD/UCD.

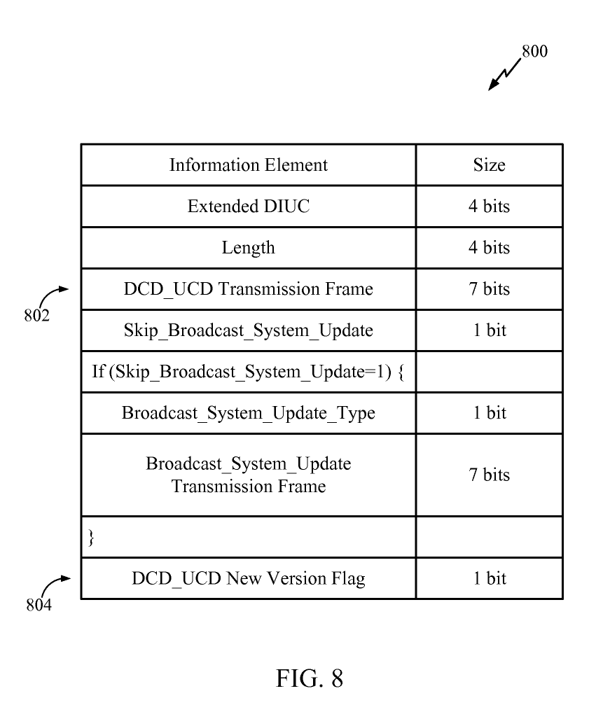

FIG. 8 illustrates an example format 800 of a Broadcast Control Pointer IE, in accordance with certain embodiments of the present disclosure. As illustrated, the IE may include a DCD_UCD New Version Flag 802 which may be set to indicate whether the version of the next broadcast DCD/UCD is new (newer than a current version). The IE may also include a DCD_UCD transmission frame 802 indicating a frame number of a frame containing a corresponding DCD/UCD message. An MS may use this information to determine if an upcoming DCD/UCD broadcast contains a new or current version and also to determine the frame number in which it will be transmitted.

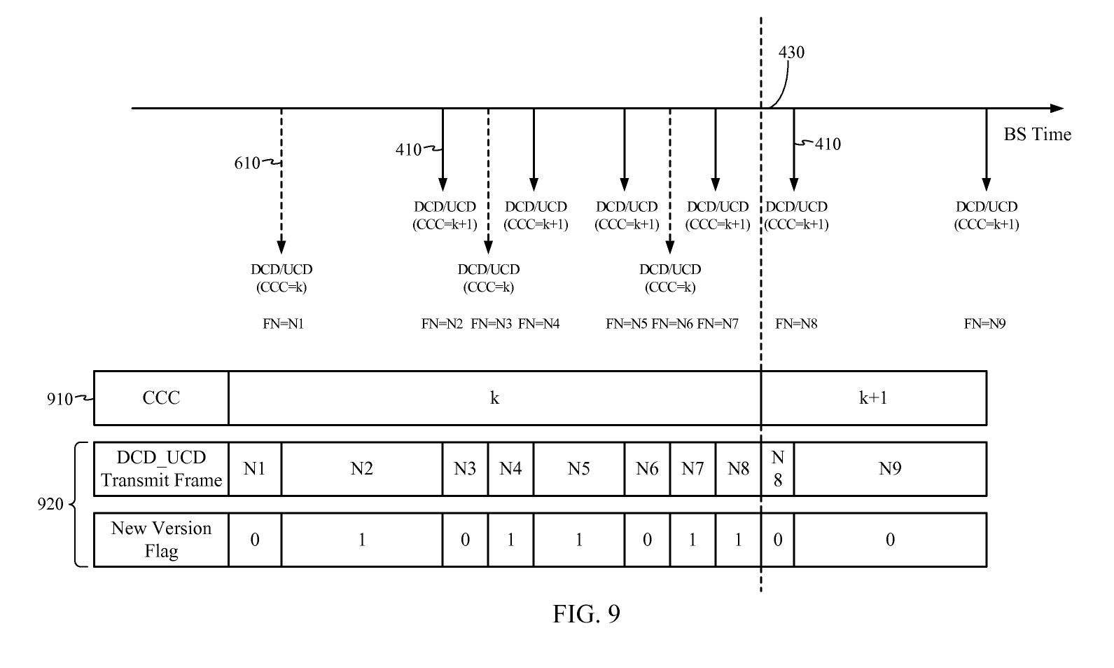

FIG. 9 illustrates example broadcasts 900 utilizing a broadcast pointer IE 920 with a new version flag and transmit frame field. As illustrated, the DCD-UCD Transmit Frame indicates the frame number of a subsequent frame that will contain a DCD/UCD message. When the subsequent frame is to contain a new version of the DCD/UCD, the New Version flag is set to 1. In this example, new versions of DCD/UCD are transmitted in frames N2, N4, N5, N7 and N8. After the new version comes into effect (CCC=k+1), the New Version Flag is set to zero for subsequent frames containing that version of the DCD/UCD.

### Exemplary Techniques for Handling an Upcoming DCD/UCD Broadcast

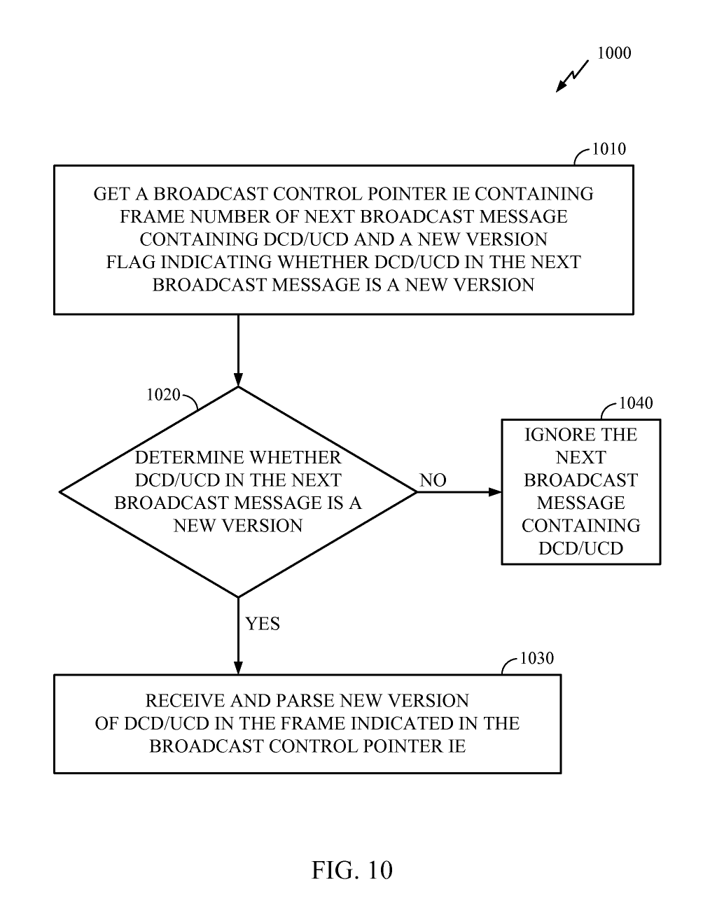

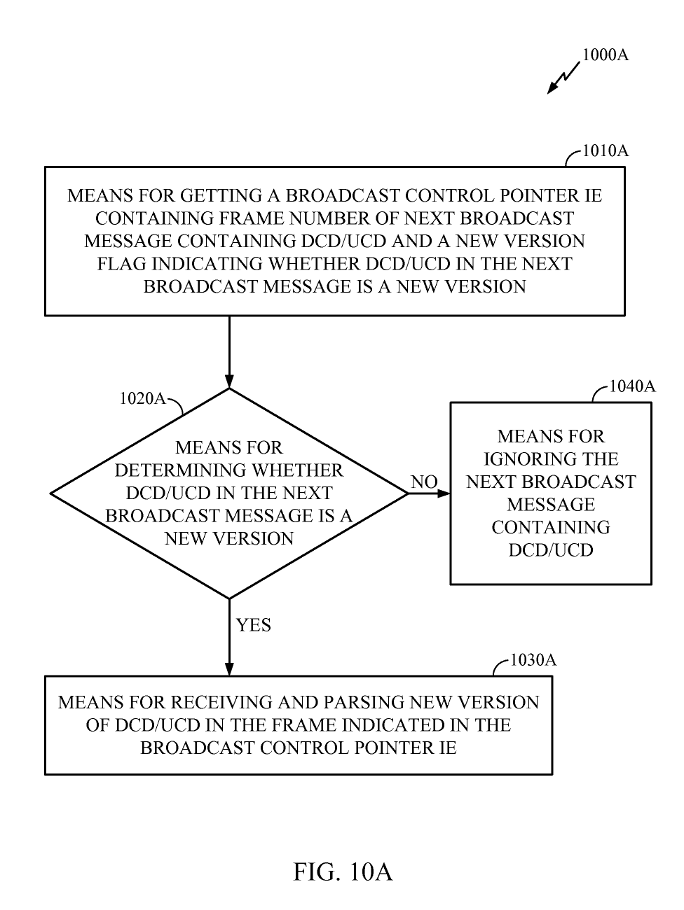

FIG. 10 illustrates example operations 1000 that may be performed, for example, by an MS for determining how to handle an upcoming DCD/UCD broadcast, in accordance with certain embodiments of the present disclosure. The example operations assume the MS already has the current version of DCD/UCD and is interested in obtaining the new version.

The operations 1000 begin at 1010, with the MS receiving a Broadcast Control Pointer IE. As illustrated in FIG. 9, the Broadcast Control Pointer IE contain a suitable field such as the DCD_UCD Transmit Frame, to indicate the frame carrying the next broadcast message with DCD/UCD, and a new version flag indicating whether the version of DCD/UCD in the message is a new version.

At 1020, the MS determines, based on the value of the new version flag, whether the version of the next broadcast DCD/UCD is new. If the MS determines that the version of the next broadcast DCD/UCD is new, the MS may receive and parse the new version of DCD/UCD present in the next broadcast message, at 1030. To accomplish this, the MS may forego activities that would make it unavailable, such as sleep mode or neighbor BS scanning, to be able to receive the new version in the indicated frame.

If the MS determines that the version of the next broadcast DCD/UCD is the current version (and the MS already has that version), at 1040, the MS may simply ignore the next broadcast message containing DCD/UCD. An advantage of this approach may be consumption of less power, since the MS may choose to go to sleep or scan during the time of the indicated frame.

The operations described above may be performed by various hardware and/or software component(s) and/or module(s) corresponding to a number of means-plus-function blocks. For example, the operations 500, 700, and 1000 of FIGS. 5, 7, and 10 may correspond to means-plus-function blocks 500A, 700A, and 1000A illustrated in FIGS. 5A, 7A, and 10A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications, comprising:
obtaining a new version of a channel descriptor (CD);
transmitting messages containing the new version of the CD and a current version of the CD, prior to the new version of the CD taking effect; and
transmitting only messages containing the new version of the CD after the new version of the CD takes effect, at least until another new version of the CD is obtained.

2. The method of claim 1, further comprising transmitting, in a broadcast control pointer information element (IE), a frame number of a frame in which a message containing the new version of the CD is to be transmitted.

3. The method of claim 2, further comprising setting a flag in the broadcast control pointer IE to indicate the new version of the CD is to be transmitted.

4. The method of claim 1, wherein transmitting messages containing the new version of the CD message and a current version of the CD message, prior to the new version of the CD message taking effect comprises:
transmitting messages containing the new version of the CD more frequently than the messages containing the current version of the CD.

5. A method for wireless communications, comprising:
receiving, from a base station, an indication that a new version of a channel descriptor (CD) is to be transmitted in a subsequent frame; and
obtaining the CD in the subsequent frame prior to the new version of the CD going into effect.

6. The method of claim 5, wherein the indication comprises a frame number of the subsequent frame in which the CD is to be transmitted.

7. The method of claim 5, wherein the indication comprises a flag indicating the version of the CD to be transmitted in the subsequent frame is new.

8. The method of claim 5, further comprising:
receiving, from a base station, an indication that a version of a channel descriptor (CD) to be transmitted in a subsequent frame is a version previously obtained; and
in response, refraining from decoding the version transmitted in the subsequent frame.

9. The method of claim 8, wherein refraining from decoding the version transmitted in the subsequent frame comprises at least one of remaining in a sleep mode and scanning neighbor base stations during the subsequent frame in which the previously obtained version of the CD is to be transmitted.

10. An apparatus for wireless communications, comprising:
logic for obtaining a new version of a channel descriptor (CD);
logic for transmitting messages containing the new version of the CD and a current version of the CD, prior to the new version of the CD taking effect; and
logic for transmitting only messages containing the new version of the CD after the new version of the CD takes effect, at least until another new version of the CD is obtained.

11. The apparatus of claim 10, further comprising logic for transmitting, in a broadcast control pointer information element (IE), a frame number of a frame in which a message containing the new version of the CD is to be transmitted.

12. The apparatus of claim 11, further comprising logic for setting a flag in the broadcast control pointer IE to indicate the new version of the CD is to be transmitted.

13. The apparatus of claim 10, wherein the logic for transmitting messages containing the new version of the CD message and a current version of the CD message, prior to the new version of the CD message taking effect comprises:
logic for transmitting messages containing the new version of the CD more frequently than the messages containing the current version of the CD.

14. An apparatus for wireless communications, comprising:
logic for receiving, from a base station, an indication that a new version of a channel descriptor (CD) is to be transmitted in a subsequent frame, the CD comprising at least one of a downlink CD (DCD) and an uplink CD (UCD); and
logic for obtaining the CD in the subsequent frame prior to the new version of the CD going into effect.

15. The apparatus of claim 14, wherein the indication comprises a frame number of the subsequent frame in which the CD is to be transmitted.

16. The apparatus of claim 14, wherein the indication comprises a flag indicating the version of the CD to be transmitted in the subsequent frame is new.

17. The apparatus of claim 14, further comprising:
logic for receiving, from a base station, an indication that a version of a channel descriptor (CD) to be transmitted in a subsequent frame is a version previously obtained and refraining from decoding the version transmitted in the subsequent frame.

18. The apparatus of claim 17, wherein refraining from decoding the version transmitted in the subsequent frame comprises at least one remaining in a sleep mode and scanning neighbor base stations during the subsequent frame in which the previously obtained version of the CD is to be transmitted.

19. An apparatus for wireless communications, comprising:
means for obtaining a new version of a channel descriptor (CD), the CD comprising at least one of a downlink CD (DCD) and an uplink CD (UCD);
means for transmitting messages containing the new version of the CD and a current version of the CD, prior to the new version of the CD taking effect; and
means for transmitting only messages containing the new version of the CD after the new version of the CD takes effect, at least until another new version of the CD is obtained.

20. The apparatus of claim 19, further comprising means for transmitting, in a broadcast control pointer information element (IE), a frame number of a frame in which a message containing the new version of the CD is to be transmitted.

21. The apparatus of claim 20, further comprising means for setting a flag in the broadcast control pointer IE to indicate the new version of the CD is to be transmitted.

22. The apparatus of claim 19, wherein the means for transmitting messages containing the new version of the CD message and a current version of the CD message, prior to the new version of the CD message taking effect comprises:
means for transmitting messages containing the new version of the CD more frequently than the messages containing the current version of the CD.

23. An apparatus for wireless communications, comprising:
means for receiving, from a base station, an indication that a new version of a channel descriptor (CD) is to be transmitted in a subsequent frame, the CD comprising at least one of a downlink CD (DCD) and an uplink CD (UCD); and
means for obtaining the CD in the subsequent frame prior to the new version of the CD going into effect.

24. The apparatus of claim 23, wherein the indication comprises a frame number of the subsequent frame in which the CD is to be transmitted.

25. The apparatus of claim 23, wherein the indication comprises a flag indicating the version of the CD to be transmitted in the subsequent frame is new.

26. The apparatus of claim 23, further comprising:
means for receiving, from a base station, an indication that a version of a channel descriptor (CD) to be transmitted in a subsequent frame is a version previously obtained and refraining from decoding the version transmitted in the subsequent frame.

27. The apparatus of claim 26, wherein refraining from decoding the version transmitted in the subsequent frame comprises at least one remaining in a sleep mode and scanning neighbor base stations during the subsequent frame in which the previously obtained version of the CD is to be transmitted.

28. A computer-program product for wireless communications, comprising a computer readable medium having instructions stored thereon, the instructions being executable by one or more processors and the instructions comprising:
instructions for obtaining a new version of a channel descriptor (CD), the CD comprising at least one of a downlink CD (DCD) and an uplink CD (UCD);
instructions for transmitting messages containing the new version of the CD and a current version of the CD, prior to the new version of the CD taking effect; and
instructions for transmitting only messages containing the new version of the CD after the new version of the CD takes effect, at least until another new version of the CD is obtained.

29. The computer-program product of claim 28, further comprising instructions for transmitting, in a broadcast control pointer information element (IE), a frame number of a frame in which a message containing the new version of the CD is to be transmitted.

30. The computer-program product of claim 29, further comprising instructions for setting a flag in the broadcast control pointer IE to indicate the new version of the CD is to be transmitted.

31. The computer-program product of claim 28, wherein the instructions for transmitting messages containing the new version of the CD message and a current version of the CD message, prior to the new version of the CD message taking effect comprise:
instructions for transmitting messages containing the new version of the CD more frequently than the messages containing the current version of the CD.

32. A computer-program product for wireless communications, comprising a computer readable medium having instructions stored thereon, the instructions being executable by one or more processors and the instructions comprising:
instructions for receiving, from a base station, an indication that a new version of a channel descriptor (CD) is to be transmitted in a subsequent frame, the CD comprising at least one of a downlink CD (DCD) and an uplink CD (UCD); and
instructions for obtaining the CD in the subsequent frame prior to the new version of the CD going into effect.

33. The computer-program product of claim 32, wherein the indication comprises a frame number of the subsequent frame in which the CD is to be transmitted.

34. The computer-program product of claim 32, wherein the indication comprises a flag indicating the version of the CD to be transmitted in the subsequent frame is new.

35. The computer-program product of claim 32, further comprising:
instructions for receiving, from a base station, an indication that a version of a channel descriptor (CD) to be transmitted in a subsequent frame is a version previously obtained; and
instructions for refraining from decoding the version transmitted in the subsequent frame.

36. The computer-program product of claim 35, wherein the instructions for refraining from decoding the version transmitted in the subsequent frame comprises at least one of instructions for remaining in a sleep mode and instructions for scanning neighbor base stations during the subsequent frame in which the previously obtained version of the CD is to be transmitted.
